(19) United States
(12) Patent Application Publication
(10) Pub. No.: US 2020/0413198 A1
(43) Pub. Date: Dec. 31, 2020

(54) BONE CONDUCTION MEMS MICROPHONE

(71) Applicant: AAC ACOUSTIC TECHNOLOGIES (SHENZHEN) CO., LTD., Shenzhen (CN)

(72) Inventors: Peng Zeng, Shenzhen (CN); Tianjiao Wang, Shenzhen (CN)

(21) Appl. No.: 16/994,683

(22) Filed: Aug. 17, 2020

Related U.S. Application Data
(63) Continuation of application No. PCT/CN2019/094063, filed on Jun. 30, 2019.

(51) Int. Cl. H04R 7/00; H04R 1/08

(52) U.S. Cl. CPC H04R 7/00; H04R 2201/003; H04R 1/08

(57) ABSTRACT

A bone conduction MEMS microphone includes a MEMS chip, a mass, a housing, and a circuit board. The MEMS chip and the housing are mounted on the same side of the circuit board. The housing and the circuit board cooperatively form a sealed chamber and the MEMS chip is accommodated in the chamber. The MEMS chip includes a back plate and a diaphragm, and the mass is fixed to the diaphragm. Since the chamber is sealed, the bone conduction MEMS microphone has no sound hole and airborne sound is therefore avoided. The mass is fixed to the diaphragm of the MEMS chip. Vibration signals of the sound transmitted through bones make the mass and the diaphragm vibrate to thereby realize conversion of sound to mechanical vibration of different frequencies, achieve clear sound restoration in a noisy environment, avoid interference from airborne noise, and ensure sound with high quality.

### FIELD OF THE INVENTION

The present disclosure relates to the field of micro-electromechanical systems, in particular to a bone conduction MEMS microphone and a mobile terminal.

### BACKGROUND

Micro-Electro-Mechanical System (MEMS) microphones are acoustoelectric transducers manufactured based on MEMS technology. MEMS microphones have characteristics of small size, good frequency response characteristics and low noise and are becoming indispensable components for mobile terminals. A MEMS microphone generally includes a MEMS chip based on capacitance detection and an ASIC chip. The capacitance of the MEMS chip changes in response to input sound signals and electrical signals are generated accordingly and sent to the ASIC chip to process and output, thereby picking up the sound signals. The MEMS chip usually includes a substrate with a back cavity, and a parallel plate capacitor comprising a back plate and a diaphragm mounted on the substrate. The diaphragm receives external sound signals and vibrates. Consequently, the parallel plate capacitor generates a variable electrical signal to thereby realize the conversion of sound to electricity.

A bone conduction microphone in the related art adds an additional vibration member based on the traditional MEMS microphones to achieve the conversion of sound into mechanical vibration of different frequencies. However, the bone conduction microphone in the related art occupies a large space, which violates the trend of the miniaturization.

### SUMMARY

Accordingly, the present disclosure is directed to a bone conduction MEMS microphone with a compact structure.

In one aspect, the present disclosure provides a bone conduction MEMS microphone which comprises a MEMS chip with a back cavity, a mass, a housing, and a circuit board. The MEMS chip and the housing are mounted to the same side of the circuit board, the housing and the circuit board cooperatively form a sealed chamber and the MEMS chip is accommodated in the sealed chamber. The MEMS chip comprises a back plate and a diaphragm facing the back plate, and the mass is fixed to the diaphragm.

In some embodiments, a connecting line between a central point of the mass and a central point of the diaphragm is perpendicular to a vibrating direction of the diaphragm.

In some embodiments, the bone conduction MEMS microphone comprises a plurality of masses which are symmetrical about a central line of the diaphragm.

In some embodiments, the mass is attached to the diaphragm of the MEMS chip via a semiconductor process or an adhesion process.

In some embodiments, the mass is attached to a side of the diaphragm close to the back cavity.

In some embodiments, the bone conduction MEMS microphone further comprises an ASIC chip connected to the MEMS chip, wherein the ASIC chip is accommodated in the sealed chamber and attached on the circuit board.

In some embodiments, the bone conduction MEMS microphone further comprises a wire which connects the MEMS chip with the ASIC chip.

In some embodiments, the ASIC chip is connected to the MEMS chip via built-in wires which are built in the circuit board.

In some embodiments, the built-in wires are built in an inner layer of the circuit board.

In another aspect, the present disclosure provides a mobile terminal comprising a bone conduction MEMS microphone described above.

Compared with the related art, in the bone conduction MEMS microphone of the present disclosure, since the chamber is sealed, the bone conduction MEMS microphone has no sound hole and the airborne sound is therefore avoided. The mass is fixed to the diaphragm of the MEMS chip. Vibration signals of the sound transmitted through the bone make the mass and the diaphragm vibrate to thereby realize conversion of sound to mechanical vibration of different frequencies, achieve clear sound restoration in a noisy environment, avoid interference from airborne noise, and ensure sound with high quality. The sound wave does not diffuse in the air to affect others, whereby avoiding generation of noise and meeting requirements of no sound interference and confidential calls in certain specific environments. The mass is attached to the diaphragm of the MEMS chip, which reduces the volume of the bone conduction MEMS microphone. The bone conduction MEMS microphone occupies a small space, which is benefit to miniaturization of mobile terminals.

### BRIEF DESCRIPTION OF THE DRAWINGS

In order to explain the technical solutions of the embodiments of the present disclosure more clearly, accompanying drawings used to describe the embodiments are briefly introduced below. It is evident that the drawings in the following description are only concerned with some embodiments of the present disclosure. For those skilled in the art, in a case where no inventive effort is made, other drawings may be obtained based on these drawings.

FIG. 1 illustrates a bone conduction MEMS microphone in accordance with an exemplary embodiment of the present disclosure.

FIG. 2 is a cross-sectional view taken along line A-A of FIG. 1.

FIG. 3 is an exploded view of the bone conduction MEMS microphone of FIG. 1.

FIG. 4 illustrates a portable mobile terminal in accordance with another exemplary embodiment of the present disclosure.

### DESCRIPTION OF REFERENCE NUMBERS

11. MEMS chip; 111, diaphragm; 112, back cavity;
113. Back plate; 12. Mass; 13. Housing; 14. Circuit board;
15. Chamber; 16. ASIC chip; 17. Wire;
1. Bone conduction MEMS microphone.

### DESCRIPTION OF THE EMBODIMENTS

The technical solutions in embodiments of the present disclosure will be clearly and completely described with reference to the accompanying drawings of the present disclosure. It is evident that the elements described are only some rather than all embodiments of the present disclosure. Based on the embodiments of the present disclosure, all other embodiments obtained by those skilled in the art without making any inventive effort fall into the protection scope of the present disclosure.

The present disclosure will be further illustrated with reference to the accompanying specific embodiments.

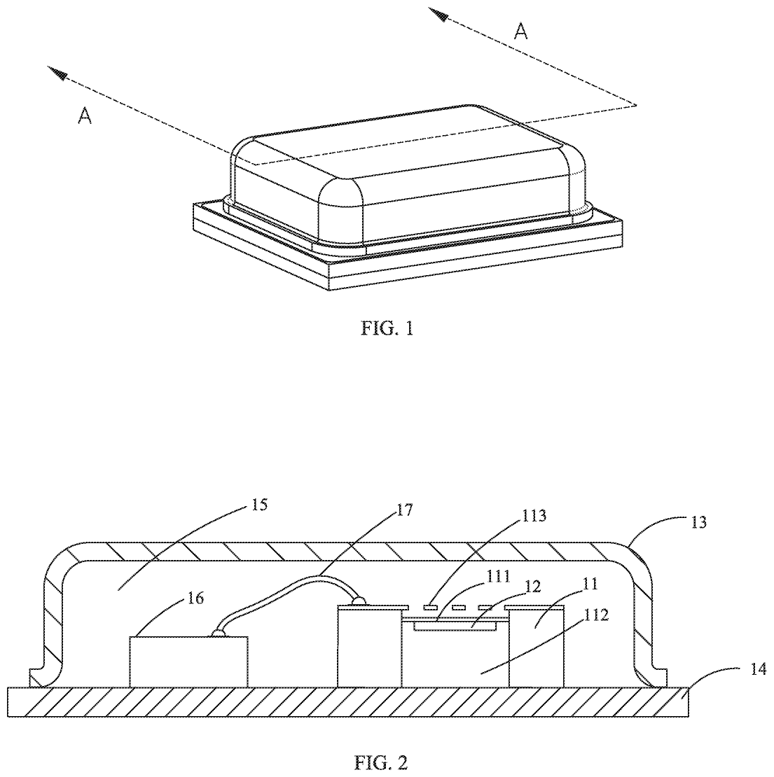

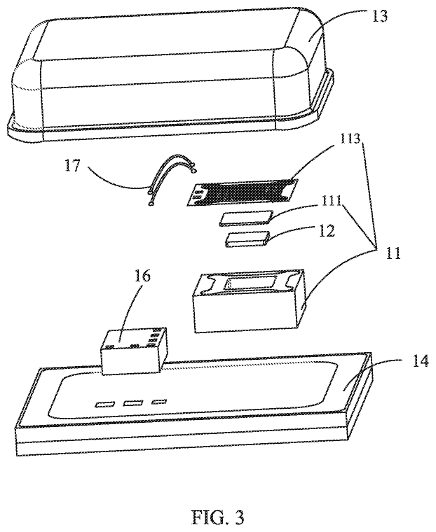

FIG. 1 illustrates a bone conduction MEMS microphone according to an embodiment of the present disclosure. FIG. 2 is a cross-sectional view taken along line A-A of FIG. 1. FIG. 3 is an exploded view of the bone conduction MEMS microphone of FIG. 1. Referring to FIGS. 1-3, the bone conduction MEMS microphone comprises a MEMS chip 11 with a back cavity 112, a mass 12, a housing 13, and a circuit board 14.

The MEMS chip 11 and the housing 13 are disposed on the same side of the circuit board 14. The housing 13 and the circuit board 14 cooperatively form a sealed chamber 15, and the MEMS chip 11 is accommodated in the chamber 15.

The MEMS chip 11 comprises a diaphragm 111 and a back plate 113 facing each other. The back plate 113 and the diaphragm 111 cooperatively form a capacitor. The mass 12 is fixed to the diaphragm 111. The diaphragm 111 and the mass 12 vibrate after receiving sound signals transmitted by bones, and the capacitance of the capacitor of the MEMS chip 11 changes consequently. Thus, the sound signals are converted to mechanical vibration of different frequencies and the sound can be restored clearly in a noisy environment, avoiding interference from airborne noise. The sound quality is improved. The sound wave does not diffuse in the air to affect others, whereby avoiding generation of noise and meeting requirements of no sound interference and confidential calls in certain specific environments.

Optionally, in order to reduce the instability when the mass 12 vibrates and improve the quality of sound transmission, in the embodiment, the line connecting the central point of the mass 12 and the central point of the diaphragm 111 is perpendicular to the vibrating direction of the diaphragm 111. In this embodiment, the number of the mass 12 may be one or multiple. When multiple masses 12 are used, the multiple masses 12 are symmetrical about the central line of the diaphragm 111. During the process of vibration, the diaphragm 111 and the masses 12 vibrate as an integral structure with the same frequency, thereby improving the stability of the mechanical vibration and the quality of sound transmission.

The mass 12 is fixed to a side of the diaphragm 111 close to the back cavity 112, and is attached to the diaphragm 111 of the MEMS chip 11 by using a semiconductor process or an adhesive process. Optionally, the mass 12 of the present disclosure can be made of elemental semiconductor material, for example silicon material, which can be attached to the diaphragm 111 using a semiconductor process or an adhesion process. The size of the mass 12 can reach a nano level, which further ensures consistency of the mass 12.

Optionally, the bone conduction MEMS microphone according to an embodiment of the present disclosure further comprises an ASIC chip 16 which is coupled to the MEMS chip 11. The ASIC chip 16 is disposed in the chamber 15 and mounted on the circuit board 14. After the MEMS chip 11 receives sound signals, the capacitance of the MEMS chip 11 changes consequently and corresponding electric signals are sent to the ASIC chip 16 for processing. Thus, the corresponding processed signals in response to the sound signals can be obtained and output to complete the sound conduction.

Optionally, the bone conduction MEMS microphone according to an embodiment of the present disclosure may further comprises a wire 17. The ASIC chip 16 is electrically connected to the MEMS chip 11 through the wire 17.

In some embodiments, the ASIC chip 16 is electrically connected to the MEMS chip 11 through one or more built-in wires which are built in the circuit board 14. Preferably, the circuit board 14 comprises a plurality of layers. When the circuit board 14 is produced, the built-in wires are disposed in the inner layer of the circuit board 14, thereby saving space on the circuit board 14 and reducing the connecting wires on the circuit board 14.

The embodiment of the present disclosure provides a bone conduction MEMS microphone which includes a MEMS chip with a back cavity, a mass, a housing, and a circuit board. The MEMS chip and the housing are disposed on the same side of the circuit board. The housing and the circuit board cooperatively form a sealed chamber and the MEMS chip is accommodated in the sealed chamber. The MEMS chip includes a back plate and a diaphragm facing and spaced from the back plate. The mass is fixed to the diaphragm. The improved bone conduction MEMS microphone of the present disclosure applies a sealed chamber without sound holes, which avoids airborne sound. The mass is fixed on the diaphragm of the MEMS chip. The vibration signals of the sound transmitted through bones make the mass and the diaphragm vibrate and the capacitance of the MEMS chip changes consequently to thereby realize conversion of sound to mechanical vibration of different frequencies, achieve clear sound restoration in a noisy environment, avoid interference from airborne noise, and ensure the sound with high quality. The sound does not diffuse in the air to affect others, whereby avoiding generation of noise and meeting requirements of no sound interference and confidential calls in certain specific environments. The mass is attached to the diaphragm of the MEMS chip, which reduces the volume of the bone conduction MEMS microphone. The bone conduction MEMS microphone occupies a small space, which is benefit to miniaturization of mobile terminals.

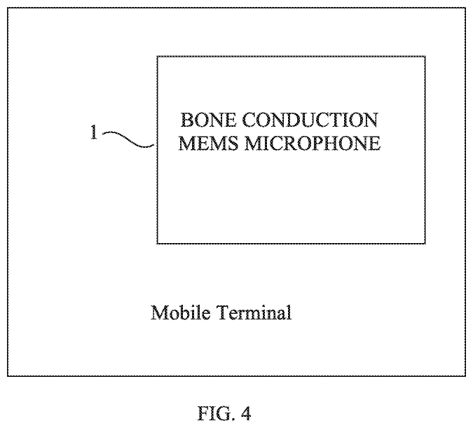

FIG. 4 is a schematic diagram of a mobile terminal according to another embodiment of the present disclosure. Referring to FIG. 4, the mobile terminal includes the above-described bone conduction MEMS microphone 1.

In the mobile terminal of the present disclosure, a conventional microphone is replaced with the improved bone conduction MEMS microphone according to an embodiment of the present disclosure. The chamber of the bone conduction MEMS microphone is sealed. The bone conduction MEMS microphone has no sound hole and the airborne sound is therefore avoided. The mass is fixed to the diaphragm of the MEMS chip. Vibration signals of the sound transmitted through the bone make the mass and the diaphragm vibrate to thereby realize conversion of sound to mechanical vibration of different frequencies, achieve clear sound restoration in a noisy environment, avoid noise interference caused by airborne sound, and ensure high sound quality. The sound wave does not spread in the air to affect others, whereby avoiding generation of noise and meeting requirements of no sound interference and confidential calls in certain specific environments. The mass is attached to the diaphragm of the MEMS chip, which reduces the volume of the bone conduction MEMS microphone. The bone conduction MEMS microphone occupies a small space, which is benefit to miniaturization of mobile terminals.

The above-described are only embodiments of the present disclosure. It shall be noted that those skilled in the art may make improvements without departing from the spirit or scope of the present disclosure. All these improvements fall into the protection scope of the present disclosure.

What is claimed is:

1. A bone conduction MEMS microphone comprising a MEMS chip with a back cavity, a mass, a housing, and a circuit board;
wherein the MEMS chip and the housing are mounted on the same side of the circuit board, the housing and the circuit board cooperatively form a sealed chamber and the MEMS chip is accommodated in the sealed chamber; and
wherein the MEMS chip comprises a back plate and a diaphragm facing the back plate, and the mass is fixed to the diaphragm.

2. The bone conduction MEMS microphone of claim 1, wherein a connecting line between a central point of the mass and a central point of the diaphragm is perpendicular to a vibrating direction of the diaphragm.

3. The bone conduction MEMS microphone of claim 1, wherein the bone conduction MEMS microphone comprises a plurality of the masses which are symmetrical about a central line of the diaphragm.

4. The bone conduction MEMS microphone of claim 1, wherein the mass is attached to the diaphragm of the MEMS chip via a semiconductor process or an adhesion process.

5. The bone conduction MEMS microphone of claim 1, wherein the mass is attached to a side of the diaphragm close to the back cavity.

6. The bone conduction MEMS microphone of claim 1, further comprising an ASIC chip connected to the MEMS chip, wherein the ASIC chip is accommodated in the sealed chamber and attached on the circuit board.

7. The bone conduction MEMS microphone of claim 6, further comprising a wire which connects the MEMS chip with the ASIC chip.

8. The bone conduction MEMS microphone of claim 6, wherein the ASIC chip is electrically connected to the MEMS chip via built-in wires which are built in the circuit board.

9. The bone conduction MEMS microphone of claim 8, wherein the built-in wires are built in an inner layer of the circuit board.

10. A mobile terminal comprising a bone conduction MEMS microphone of claim 1.
